(19) United States
(12) Patent Application Publication
(10) Pub. No.: US 2020/0369295 A1
(43) Pub. Date: Nov. 26, 2020

(54) SYSTEM FOR DETERMINING DRIVER OPERATING OF AUTONOMOUS VEHICLE AND METHOD THEREFOR

(71) Applicant: OPEL Solution Inc., Daejeon (KR)

(72) Inventors: Jin Young YANG, Seoul (KR); Jae Hyung PARK, Seoul (KR)

(21) Appl. No.: 16/875,661

(22) Filed: May 15, 2020

(30) Foreign Application Priority Data
May 21, 2019 (KR) 10-2019-0059553

(51) Int. Cl. B60W 60/00; B60W 50/14; G07C 5/08; B60W 40/04; B60W 40/06; B60W 50/10

(52) U.S. Cl. CPC B60W 60/0025; B60W 50/14; G07C 5/0841; B60W 2552/05; B60W 40/06; B60W 50/10; B60W 2050/143; B60W 40/04

(57) ABSTRACT

Disclosed is a system and method for determining whether a driver of an autonomous vehicle intervenes. According to an exemplary embodiment, in the system determining whether a driver of an autonomous vehicle intervenes, the system determining whether a driver of an autonomous vehicle intervenes includes a reception unit receiving vehicle data, which is On-Board Diagnostics (OBD) data for vehicle manipulation and operation, collected from an OBD dongle, an identification unit identifying a source commanding an operation command for driving of the autonomous vehicle through analysis of the received vehicle data, and a determination unit determining whether the driver intervenes, through the identification of the source commanding the operation command.

### CROSS-REFERENCE TO RELATED APPLICATIONS

A claim for priority under 35 U.S.C. § 119 is made to Korean Patent Application No. 10-2019-0059553 filed on May 21, 2019, in the Korean Intellectual Property Office, the entire contents of which are hereby incorporated by reference.

### BACKGROUND OF THE INVENTION

Embodiments of the inventive concept described herein relate to a technology for determining whether a driver intervenes in an autonomous vehicle, and more particularly, relate to a system that may determine whether a driver intervenes based on vehicle data received from an On-Board Diagnostics (OBD) dongle connected to an autonomous vehicle, and a method therefor.

With the development of the advanced technologies and IT industries, the research of the unmanned industry may be developed and applied in various fields. In particular, a vehicle industry has recently been changed in the era of eco-friendly and high-tech vehicles combined with IT technologies. With the development of vehicle technology, an intelligent vehicle equipped with technologies of accident prevention, accident avoidance, collision safety, convenience improvement, vehicle information, autonomous technology, and the like is commercially available to increase driver safety and convenience.

Such the intelligent vehicle is a vehicle that supports technologies for the carelessness or unskilled operation of a driver or convenience functions through speech recognition; such the intelligent vehicle not only reduces accidents due to driver errors, but also reduces time, fuel consumption, and exhaust gas.

The autonomous vehicle is the collection of intelligent vehicle technologies. When the driver boards the vehicle and sets the desired destination, the autonomous vehicle may generate the optimal route from the current location to the destination and then may drive without any special manipulation.

Furthermore, the autonomous vehicle may recognize road traffic signals and signs, may maintain the proper speed suitable for traffic conditions, may actively cope with accident prevention by recognizing breakdown situations, may keep a lane, and may make appropriate steering to change a lane, to overtake other vehicles, or to avoid obstacles if necessary; accordingly, the autonomous vehicle may drive to the desired destination.

As described above, the autonomous driving of autonomous vehicles has been recently studied very much. The autonomous system may allow a vehicle to move while automatically controlling the vehicle's driving from the start point to the end point on a road, using GPS position information and signals obtained from various sensors based on road map information.

That is, the autonomous system may detect the surrounding environment of a vehicle through various sensors provided in the vehicle and may allow the vehicle to autonomously drive by instructing commands through various types of driving control units provided in the vehicle based on information about the surrounding environment.

### SUMMARY

Embodiments of the inventive concept provide a system that may determine whether a driver intervenes based on vehicle data received from an OBD dongle connected to an autonomous vehicle, and a method therefor.

According to an exemplary embodiment, in the system determining whether a driver of an autonomous vehicle intervenes, the system determining whether a driver of an autonomous vehicle intervenes includes a reception unit receiving vehicle data, which is On-Board Diagnostics (OBD) data for vehicle manipulation and operation, collected from an OBD dongle, an identification unit identifying a source commanding an operation command for driving of the autonomous vehicle through analysis of the received vehicle data, and a determination unit determining whether the driver intervenes, through the identification of the source commanding the operation command.

The identification unit may identify whether the source commanding the operation command for the driving of the autonomous vehicle is received from the driver or an autonomous agent, through the analysis of the vehicle data.

Furthermore, according to an exemplary embodiment of the inventive concept, the system determining whether a driver of an autonomous vehicle intervenes may further include a provision unit generating intervention pattern information about intervention of the driver to provide the driver with the intervention pattern information and comparing the intervention pattern information with preset reference information to provide a visual or audio alarm associated with the intervention of the driver.

The determination unit may evaluate stability of autonomous driving based on situation information including at least one of whether devices necessary for the autonomous driving of the autonomous vehicle fail, weather at a current location, time, a traffic condition, and road information.

Furthermore, according to an exemplary embodiment of the inventive concept, the system determining whether a driver of an autonomous vehicle intervenes may further include a provision unit providing the driver with recommendation information for recommending intervention of the driver when the stability of the autonomous driving is lower than a preset reference stability.

The determination unit may determine whether the driver intervenes in at least one of deceleration, acceleration, steering, gear shifting, and an operation of a turn signal of the autonomous vehicle, intervention time in which the driver intervenes, and intervention strength of the driver.

According to an exemplary embodiment, in a method of determining whether a driver of an autonomous vehicle intervenes, a method of determining whether a driver of an autonomous vehicle intervenes may include receiving vehicle data, which is OBD data for vehicle manipulation and operation, collected from an OBD dongle, identifying a source commanding an operation command for driving of the autonomous vehicle through analysis of the received vehicle data, and determining whether the driver intervenes, through the identification of the source commanding the operation command.

The identifying may include identifying whether the source commanding the operation command for the driving of the autonomous vehicle is received from the driver or an autonomous agent, through the analysis of the vehicle data.

Furthermore, according to an exemplary embodiment of the inventive concept, a method of determining whether a driver of an autonomous vehicle intervenes may further include generating intervention pattern information about intervention of the driver to provide the driver with the intervention pattern information and comparing the intervention pattern information with preset reference information to provide a visual or audio alarm associated with the intervention of the driver.

The determining may include evaluating stability of autonomous driving based on situation information including at least one of whether devices necessary for the autonomous driving of the autonomous vehicle fail, weather at a current location, time, a traffic condition, and road information.

Furthermore, according to an exemplary embodiment of the inventive concept, a method of determining whether a driver of an autonomous vehicle intervenes may further include providing the driver with recommendation information for recommending intervention of the driver when the stability of the autonomous driving is lower than a preset reference stability.

The determining may include determining whether the driver intervenes in at least one of deceleration, acceleration, steering, gear shifting, and an operation of a turn signal of the autonomous vehicle, intervention time in which the driver intervenes, and intervention strength of the driver.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a diagram illustrating a relationship between an OBD dongle, a mobile device, and a server, according to an embodiment of the inventive concept;

FIG. 2 illustrates a configuration diagram of an embodiment for describing an internal configuration of a mobile device and a server illustrated in FIG. 1;

FIG. 3 illustrates an operation flowchart of a method in which an autonomous vehicle determines whether a driver intervenes, according to an embodiment of the inventive concept; and

FIG. 4 illustrates a configuration of a system in which an autonomous vehicle determines whether a driver intervenes, according to an embodiment of the inventive concept.

### DETAILED DESCRIPTION OF CERTAIN INVENTIVE EMBODIMENTS

Advantage points and features of the inventive concept and a method of accomplishing thereof will become apparent from the following description with reference to the following figures, wherein embodiments will be described in detail with reference to the accompanying drawings. The inventive concept, however, may be embodied in various different forms, and should not be construed as being limited only to the illustrated embodiments. Rather, these embodiments are provided as examples so that the inventive concept will be thorough and complete, and will fully convey the concept of the inventive concept to those skilled in the art. The inventive concept may be defined by scope of the claims. Meanwhile, the terminology used herein to describe embodiments of the invention is not intended to limit the scope of the invention.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other components, steps, operations, and/or elements in addition to the aforementioned components, steps, operations, and/or elements.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings. The same reference numerals are used for the same components in the drawings and redundant explanations for the same components are omitted.

Embodiments of the inventive concept is to determine whether a driver intervenes in an autonomous vehicle by analyzing vehicle data, which is OBD data for the manipulation and operation of the autonomous vehicle collected from an OBD dongle attached or connected to the autonomous vehicle.

Herein, the inventive concept may not only determine whether a driver intervenes, through the analysis of vehicle data but also may evaluate the stability of autonomous driving based on situation information including at least one of whether devices necessary for autonomous driving of the autonomous vehicle fail, weather at the current location, time, traffic conditions, and road information; the inventive concept may allow the driver to intervene in the autonomous vehicle to drive for the purpose of preventing an accident by providing the driver with recommended information for recommending the driver's intervention when the stability of autonomous driving is lower than the standard stability.

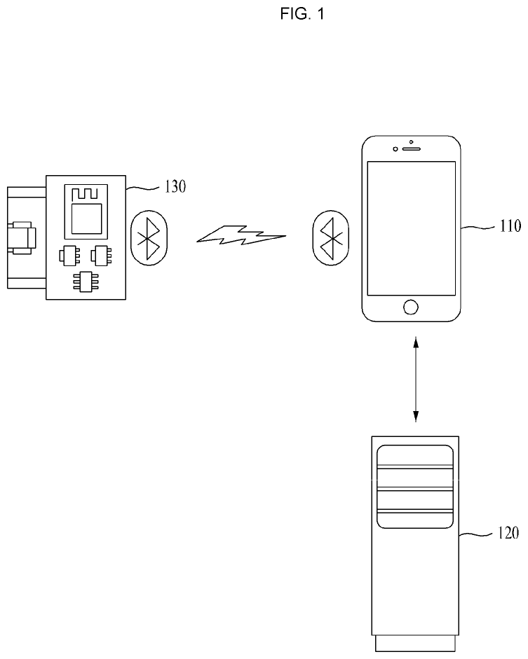

FIG. 1 is a diagram illustrating a relationship between an OBD dongle, a mobile device, and a server in a system according to an embodiment of the inventive concept.

Referring to FIG. 1, the system according to an embodiment of the inventive concept includes an OBD dongle 130, a mobile device 110, and a server 120. At this time, the OBD dongle 130 and the mobile device 110 may be capable of short-range wireless communication using Bluetooth; the mobile device 110 and the server 120 may be capable of wireless data communication connection such as Ethernet/3G, 4G, and 5G. Also, The OBD dongle 130 may comprise a communication module (ex. MODEM) to directly communicate with the server 120.

The OBD dongle 130 provides OBD data (or vehicle data) collected from the OBD interface of an autonomous vehicle, to the mobile device 110 via short-range wireless communication.

The OBD dongle 130 may be connected to the OBD interface in a vehicle using a connector including the layout of a plurality of pins and a communication method and may collect the OBD data generated from the OBD interface. In addition, the OBD dongle 130 may be mounted inside the vehicle and may detect vehicle diagnostic information including sensor information and driving information as well as operation information in the vehicle. For example, the OBD dongle 130 may collect, from the OBD interface, at least one or more pieces of OBD data of whether the vehicle is driven, vehicle speed, visibility information, revolutions per minute (RPM) of an engine, an acceleration position, a brake pedal position, an engine coolant temperature, a vehicle voltage, a battery voltage, an idling time, a fuel level, fuel efficiency, a chassis number, a gear position, a turn signal, whether a safety belt is present, the steering angle of a steering wheel, and a mileage. However, the OBD data collected in the OBD interface in the vehicle is not limited to that above described.

According to an embodiment, among the collected OBD data, the vehicle data may be preset or may be selected by the OBD dongle 130 depending on a driver's selection input received via the mobile device 110. For example, the OBD dongle 130 may collect only the OBD data depending on the preset data or the selection input of the driver from the OBD data of whether the vehicle is driven, vehicle speed, visibility information, RPM of an engine, an acceleration position, a brake pedal position, an engine coolant temperature, a vehicle voltage, a battery voltage, an idling time, a fuel level, fuel efficiency, a chassis number, a gear position, a turn signal, whether a safety belt is present, the steering angle of a steering wheel, and a mileage, which are capable of being collected from the OBD interface and may provide the mobile device 110 with the OBD data through short-range wireless communication.

At this time, the OBD data selected from the OBD data may be the preset data and may be selected with a control command (or a command) according to the driver's selection input received through the mobile device 110. The inventive concept may minimize overload and power consumption due to a large amount of information by extracting and using only the data associated with autonomous driving and data obtained in the case where the driver may intervene in autonomous driving, from among pieces of OBD data collected in the OBD interface.

The mobile device 110 may provide vehicle data received from the OBD dongle 130 to the server 120, that is, a server for determining whether the driver intervenes; the mobile device 110 may display information or alarms received from the server 120 on a screen or may output the information or alarms through a speaker.

At this time, the mobile device 110 is a mobile terminal device possessed by a driver who drives and owns the vehicle; for example, the mobile device 110 may be PC, a mobile communication terminal, a smartphone, a notepad, a personal digital assistant (PDA), or a tablet PC and may be an electronic device equipped with a wired/wireless communication module. Furthermore, the mobile device 110 may be installed with an application associated with the inventive concept; the mobile device 110 may use data associated with autonomous driving and the driver's intervention provided by the inventive concept, through an application.

The mobile device 110 may receive a driver intervention pattern generated by the server 120 or receive statistical information to display the driver intervention pattern or the statistical information; when the driver needs to intervene in autonomous driving, the mobile device 110 may receive information indicating that the driver intervenes in autonomous driving from the server 120 and then may display the information or may audibly provide the information.

Moreover, the mobile device 110 may perform the determination of whether the driver intervenes, instead of the server 120. For example, the mobile device 110 may continuously collect the vehicle data received from the OBD dongle 130 to train driving patterns and driving habits by the driver's intervention. For example, the mobile device 110 may train the driver's sudden stop or quick start based on the speed information according to the change of the gear position; the mobile device 110 may train the driver's driving pattern and driving habits upon changing a lane, based on speed information according to lane change on the left or right side; the mobile device 110 may train the overspeed of the driver on the curve based on the speed information according to the operation of a steering wheel. Furthermore, the mobile device 110 may provide the server 120 with data associated with the trained driving pattern and driving habits of the driver and then may or may not recommend the driver's intervention in an autonomous vehicle.

In some cases, the mobile device 110 may immediately display the vehicle data received from the OBD dongle 130.

The server 120 receives vehicle data, which is OBD data for the operation and driving of a vehicle collected from the OBD dongle 130, through the mobile device 110 and determines whether the driver intervenes during autonomous driving in the autonomous vehicle, through the analysis of the received vehicle data. For example, the server 120 may identify the source that commands the operation associated with autonomous driving, through the analysis of vehicle data; accordingly, the server 120 may identify whether the corresponding operation command is received from a driver or an autonomous agent, and then may determine whether the driver intervenes and the type of the intervention. In addition, because the server 120 may determine whether the driver intervenes, through the analysis of vehicle data, when the vehicle data is received in real time from the OBD dongle 130, the server 120 may determine whether the driver intervenes, in real time; when the server 120 stores various pieces of data in the OBD dongle or the storage device connected to the OBD dongle and then the various pieces of data is received, periodically or at the request of the driver, the server 120 may later determine whether the driver intervenes.

At this time, the server 120 may analyze vehicle data, which is OBD data of an autonomous vehicle, to determine whether the driver intervenes during autonomous driving, the driver's intervention time, the driver's intervention intensity, or the like. According to an embodiment, the server 120 may determine whether the driver intervenes in deceleration (brake), acceleration, steering, gear shifting, the operation of a turn signal, or the like; the server 120 may determine the driver's intervention strength. For example, the server 120 may determine that sudden deceleration, sudden acceleration, or the rotation with the great turn angle is strong intervention and may determine that fine steering (or steering wheel operation) is weak intervention.

Furthermore, the server 120 may generate intervention pattern information about the driver's intervention during autonomous driving and then may provide the intervention pattern information to the driver by providing the generated intervention pattern information to the mobile device 110; the server 120 may compare the intervention pattern information with preset reference information to provide the mobile device 110 with the visual or audio alarm associated with the driver's intervention. Accordingly, the server 120 may provide information capable of being generated by the driver's intervention during autonomous driving or information for making a request for the driver's intervention, such that the driver may or may not intervene in autonomous driving. In addition, the intervention pattern information may be generated and provided, in real time, periodically, or at the request of the driver.

Furthermore, the server 120 may statistically evaluate the stability of autonomous driving for autonomous vehicles or driving by the driver's intervention and may or may not recommend whether the driver intervenes during autonomous driving, based on statistical evaluation. That is, when it is determined by the statistics for autonomous driving that the situation is more stable in the case where the driver intervenes, the server 120 may provide the mobile device 110 with information for recommending the driver's intervention; when it is determined that the situation is more stable in the case where the driver does not intervene, the server 120 may provide the mobile device 110 with information for not recommending the driver's intervention. In addition, the determination using the statistics may be made in consideration of the pre-stored driving route of the autonomous vehicle of a driver, whether autonomous driving according to a location is performed or whether the driver intervenes, pre-evaluated safety level according to the driving route, the location, and whether the driver intervenes, the accident history of the driver of the autonomous vehicle and whether the driver intervenes in the case of accidents, if necessary, or the like.

The server 120 may evaluate the stability of autonomous driving based on situation information including at least one of whether devices (e.g., camera sensors, radar, Lidar, and other ADAS devices) necessary for autonomous driving of the autonomous vehicle fail, weather at the current location, time, traffic conditions, and road information and may provide the mobile device 110 with an alarm for recommending or not recommending the driver's intervention based on the evaluated stability. At this time, the server 120 may provide the mobile device 110 with the current state (e.g., information about whether there is a failure, accuracy, or the like) of the device necessary for autonomous driving through the analysis of the OBD data to display the current state.

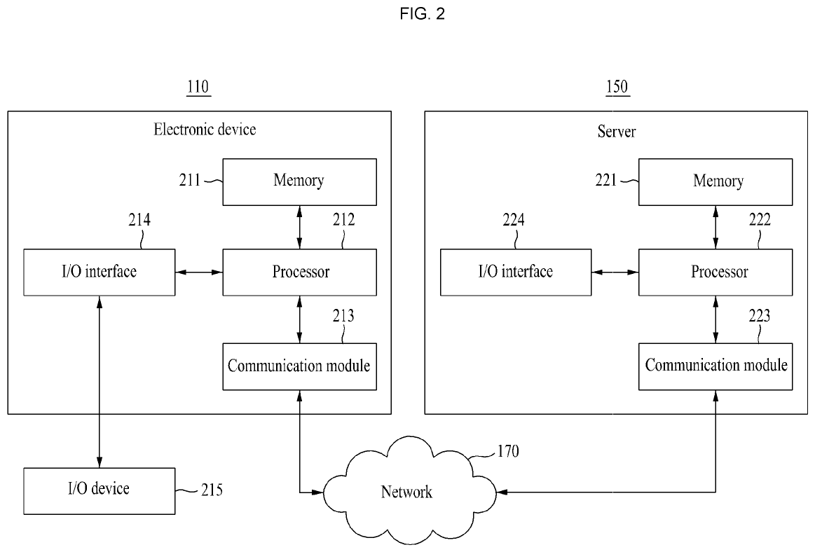

FIG. 2 illustrates a configuration diagram of an embodiment for describing an internal configuration of a mobile device and a server illustrated in FIG. 1. The inventive concept is not limited to the configuration shown in FIG. 2 and may include various hardware configurations associated with the inventive concept.

As illustrated in FIG. 2, the mobile device 110 and the server 120 may include memories 211 and 221, processors 212 and 222, communication modules 213 and 223, and input/output interfaces 214 and 224, respectively. Each of the memories 211 and 221 may be a computer-readable recording medium and may include a permanent mass storage device such as a random access memory (RAM), a read only memory (ROM), and a disc drive. Also, each of the memories 211 and 221 may store OS and at least one program code (e.g., a code for an application or the like installed and driven in the mobile device 110). These software components may be loaded from a computer-readable recording medium, which is independent of the memories 211 and 221. This computer-readable recording medium may include computer-readable recording media such as a floppy drive, a disc, a tape, a digital versatile disc (DVD)/compact disc-ROM (CD-ROM) drive, and a memory card. In another exemplary embodiment, the software components may be loaded into the memories 211 and 221 through the communication modules 213 and 223, respectively, not a computer-readable recording medium. For example, at least one program may be loaded into each of the memories 211 and 221 based on a program installed by files provided by developers or a file distribution system, which distributes a file for installing an application, through a network 170.

Each of the processors 212 and 222 may be configured to process an instruction of a computer program by performing basic arithmetic, logic, and input and output operations. The instruction may be provided to the processor 212 by the memory 211 or the communication module 213; the instruction may be provided to the processor 222 by the memory 221 or the communication module 223. For example, each of the processor 212 and 222 may be configured to execute instructions received depending on a program code stored in a storage device such as the memories 211 and 221.

Each of the communication modules 213 and 223 may provide a function such that the mobile device 110 and the server 120 communicate with each other through the network 170 and may provide a function for communicating with another electronic device and another server. For example, the request generated by the processor 212 of the mobile device 110 depending on the program code stored in a recording device such as the memory 211 may be delivered to the server 120 through the network 170 under control of the communication module 213. In contrast, a control signal or instruction, content, a file, and the like to be provided under control of the processor 222 of the server 120 may be received by the mobile device 110 through the communication 213 of the mobile device 110, via the communication module 223 and the network 170. For example, the control signal or instruction of the server 120, received through the communication module 213, may be delivered to the processor 212 or the memory 211. The content or file of the server 120 may be stored in a storing medium which may be further included in the mobile device 110.

The input/output interface 214 may be a means for interfacing with an input/output device 215. For one example, the input device may include a device such as a mouse or a keyboard. The output device may include a device such as a display for displaying a communication session of an application. For another example, the input/output interface 214 may be a means for interfacing with a device, such as a touch screen, in which an input function and an output function are integrated into one. Specifically, in processing an instruction of a computer program loaded into the memory 211, the processor 212 of the mobile device 110 may display a service screen or content, configured using data provided from the server 120, on a display of the mobile device 110 through the input/output interface 214. When the processor 222 of the server 120 processes instructions of a computer program loaded onto the memory 221, the input/output interface 224 may also output information configured using the data provided by the server 120.

Also, in other embodiments, the mobile device 110 and the server 120 may include more components than those shown in FIG. 2. However, there is no need to clearly illustrate most conventional components. For example, the mobile device 110 may be implemented to include at least some of components of the above-mentioned input/output device 215 or may further include other components such as a transceiver, a global positioning system (GPS) module, a camera, various sensors, and a database. More specifically, it may be seen that various components, such as an acceleration sensor, a gyro sensor, a camera, various physical buttons, buttons using a touch panel, input/output ports, a vibrator for vibration, and the like, which are generally included in a smartphone, may be implemented to be further included in the mobile device 110 when the mobile device 110 is a smartphone.

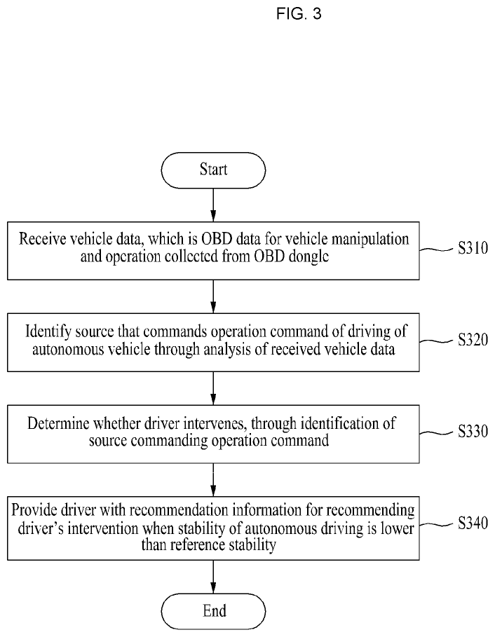

FIG. 3 illustrates an operation flowchart of a method in which an autonomous vehicle determines whether a driver intervenes, according to an embodiment of the inventive concept and illustrates an operation flowchart in the server 120 illustrated in FIG. 1.

Referring to FIG. 3, in operation S310, the method according to an embodiment of the inventive concept receives vehicle data, which is OBD data for vehicle manipulation and vehicle operation collected from an OBD dongle, through a mobile device.

Herein, an embodiment is exemplified in operation S310 as vehicle data is received through a mobile device, but is not limited thereto. The vehicle data may be directly received from the OBD dongle.

When the vehicle data of the autonomous vehicle is received through operation S310, in operation S320, the method identifies a source that commands the operation command of the driving of the autonomous vehicle through the analysis of the vehicle data.

Herein, in operation S320, it is possible to determine where the operation command for autonomous driving of the autonomous vehicle is transmitted, by identifying whether the source that commands the operation command for the driving of the autonomous vehicle is received from a driver or an autonomous vehicle agent, through the analysis of the vehicle data.

When the source commanding the operation command for the driving of the autonomous vehicle is identified in operation S320, in operation S330, the method determines whether the driver intervenes, through the identification of the source commanding the operation command.

This is, in operation S330, the method determines that the driver intervenes during autonomous driving, may calculate the intervention time of the driver, and may also determine the intervention intensity for the driver's intervention, when it is determined that the source commanding the operation command for the driving of the autonomous vehicle is received from the driver. For example, in operation S330, the method may determine that sudden deceleration, sudden acceleration, or the rotation with the great turn angle is strong intervention and may determine that fine steering operation of a steering wheel or the case acceleration or deceleration occurs within a preset range is weak intervention.

When it is determined in operation S330 that the driver intervenes, it is possible to allow the driver to quickly identify this information by providing the relevant information (e.g., problem capable of being caused by the driver's intervention during the autonomous driving of the autonomous vehicle, information changed due to the intervention, or the like) to the driver's mobile device.

Also, the method according to an embodiment of the inventive concept evaluates the stability for autonomous driving of the autonomous vehicle; when the evaluated stability is lower than the preset reference stability, the method according to an embodiment of the inventive concept provides the driver with the recommendation information by providing the mobile device with the recommendation information for recommending the driver's intervention, in operation S340.

Herein, in operation S340, the method may evaluate the stability of autonomous driving based on situation information such as whether devices (e.g., camera sensors, radar, Lidar, and other ADAS devices) necessary for autonomous driving of the autonomous vehicle fail, weather at the current location, time, traffic conditions, and road information.

Furthermore, the method according to an embodiment of the inventive concept may provide the mobile device with the current state, (e.g., information about whether there is a failure, accuracy, or the like) of the device necessary for autonomous driving through the analysis of the OBD data.

Furthermore, the method according to an embodiment of the inventive concept may generate intervention pattern information about the driver's intervention during autonomous driving and then may provide the intervention pattern information to the driver by providing the generated intervention pattern information to the mobile device; the method may compare the intervention pattern information with preset reference information to provide the mobile device with the visual or audio alarm associated with the driver's intervention. Accordingly, the method may provide information capable of being generated by the driver's intervention during autonomous driving or information for making a request for the driver's intervention, such that the driver may or may not intervene in autonomous driving.

Furthermore, the method according to an embodiment of the inventive concept may statistically evaluate the stability of autonomous driving for autonomous vehicles or driving by the driver's intervention and may or may not recommend whether the driver intervenes during autonomous driving, based on statistical evaluation. That is, when it is determined by the statistics for autonomous driving that the situation is more stable in the case where the driver intervenes, the method according to an embodiment of the inventive concept may provide the mobile device with information for recommending the driver's intervention; when it is determined that the situation is more stable in the case where the driver does not intervene, the method may provide the mobile device with information for not recommending the driver's intervention.

As such, the method according to an embodiment of the inventive concept may identify whether the operation command is received from a driver or an autonomous agent and then may determine whether the driver of an autonomous vehicle intervenes based on the identified result, by analyzing vehicle data received from an OBD dongle connected to the autonomous vehicle to identify the source that commands the operation of autonomous driving.

Moreover, when devices associated with autonomous driving, such as camera sensors, radar, Lidar, and other Advanced Driver Assistance Systems (ADAS) devices, and the like fail, the method according to an embodiment of the inventive concept may prevent an accident that may occur in the failure of the autonomous vehicle by providing information about the failure to the driver to recommend the driver's intervention.

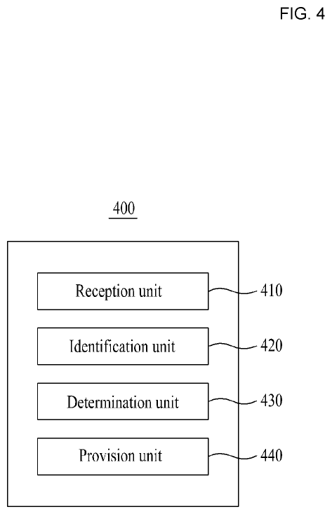

FIG. 4 illustrates a configuration of a system in which an autonomous vehicle determines whether a driver intervenes, according to an embodiment of the inventive concept and illustrates a conceptual configuration of a server illustrated in FIG. 1.

Referring to FIG. 4, a system 400 according to an embodiment of the inventive concept includes a reception unit 410, an identification unit 420, a determination unit 430, and a provision unit 440.

The reception unit 410 receives vehicle data, which is OBD data for vehicle manipulation and vehicle operation collected from an OBD dongle, through a mobile device.

The identification unit 420 identifies the source commanding an operation command for driving of the autonomous vehicle through the analysis of the vehicle data.

Herein, the identification unit 420 may determine where the operation command for autonomous driving of the autonomous vehicle is transmitted, by identifying whether the source that commands the operation command for the driving of the autonomous vehicle is received from a driver or an autonomous vehicle agent, through the analysis of the vehicle data.

When the source commanding the operation command for the driving of the autonomous vehicle is identified, the determination unit 430 determines whether the driver intervenes, through the identification of the source commanding the operation command.

Herein, the determination unit 430 may determine that the driver intervenes during autonomous driving, may calculate the intervention time of the driver, and may also determine the intervention intensity for the driver's intervention, when it is determined that the source commanding the operation command for the driving of the autonomous vehicle is received from the driver.

Furthermore, the determination unit 430 may evaluate the stability of autonomous driving based on situation information such as whether devices (e.g., camera sensors, radar, Lidar, and other ADAS devices) necessary for autonomous driving of the autonomous vehicle fail, weather at the current location, time, traffic conditions, and road information.

The provision unit 440 evaluates the stability for autonomous driving of the autonomous vehicle; when the evaluated stability is lower than the preset reference stability, the method according to an embodiment of the inventive concept provides the driver with the recommendation information by providing the mobile device with the recommendation information for recommending the driver's intervention.

Furthermore, the provision unit 440 may provide the mobile device with the current state, (e.g., information about whether there is a failure, accuracy, or the like) of the device necessary for autonomous driving through the analysis of the OBD data.

Furthermore, the provision unit 440 may generate intervention pattern information about the driver's intervention during autonomous driving and then may provide the intervention pattern information to the driver by providing the generated intervention pattern information to the mobile device; the provision unit 440 may compare the intervention pattern information with preset reference information to provide the mobile device with the visual or audio alarm associated with the driver's intervention.

Furthermore, the provision unit 440 may statistically evaluate the stability of autonomous driving for autonomous vehicles or driving by the driver's intervention and may or may not recommend whether the driver intervenes during autonomous driving, based on statistical evaluation.

Even though the description is omitted in the system in FIG. 4, it will be apparent to those skilled in the art that the system in FIG. 4 may include all content described in FIGS. 1 to 3.

The above-described system or device may be implemented with hardware elements, software elements, and/or a combination of hardware elements and software elements. For example, the systems, devices, and components described in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may perform an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and be stored or executed in a dispersion manner. Software and data may be recorded in one or more computer-readable storage media.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

According to embodiments of the inventive concept, it is possible to identify whether the operation command is received from a driver or an autonomous agent and then to determine whether the driver of an autonomous vehicle intervenes based on the identified result, by analyzing vehicle data received from an OBD dongle connected to the autonomous vehicle to identify the source that commands the operation of autonomous driving.

According to embodiments of the inventive concept, when devices associated with autonomous driving, such as camera sensors, radar, Lidar, and other Advanced Driver Assistance Systems (ADAS) devices, and the like fail, it is possible to prevent an accident that may occur in the failure of the autonomous vehicle by providing information about the failure to the driver to recommend the driver's intervention.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A system determining whether a driver of an autonomous vehicle intervenes, the system comprising:
a reception unit configured to receive vehicle data, which is On-Board Diagnostics (OBD) data for vehicle manipulation and operation, collected from an OBD dongle;
an identification unit configured to identify a source commanding an operation command for driving of the autonomous vehicle through analysis of the received vehicle data; and
a determination unit configured to determine whether the driver intervenes, through the identification of the source commanding the operation command.

2. The system of claim 1, wherein the identification unit identifies whether the source commanding the operation command for the driving of the autonomous vehicle is received from the driver or an autonomous agent, through the analysis of the vehicle data.

3. The system of claim 1, further comprising:
a provision unit, wherein the provision unit is configured to:
generate intervention pattern information about intervention of the driver to provide the driver with the intervention pattern information; and
compare the intervention pattern information with preset reference information to provide a visual or audio alarm associated with the intervention of the driver.

4. The system of claim 1, wherein the determination unit evaluates stability of autonomous driving based on situation information including at least one of whether devices necessary for the autonomous driving of the autonomous vehicle fail, weather at a current location, time, a traffic condition, and road information.

5. The system of claim 4, further comprising:
a provision unit configured to provide the driver with recommendation information for recommending intervention of the driver when the stability of the autonomous driving is lower than a preset reference stability.

6. The system of claim 1, wherein the determination unit determines whether the driver intervenes in at least one of deceleration, acceleration, steering, gear shifting, and an operation of a turn signal of the autonomous vehicle, intervention time in which the driver intervenes, and intervention strength of the driver.

7. A method of determining whether a driver of an autonomous vehicle intervenes, the method comprising:
receiving vehicle data, which is OBD data for vehicle manipulation and operation, collected from an OBD dongle;
identifying a source commanding an operation command for driving of the autonomous vehicle through analysis of the received vehicle data; and
determining whether the driver intervenes, through the identification of the source commanding the operation command.

8. The method of claim 7, wherein the identifying includes:
identifying whether the source commanding the operation command for the driving of the autonomous vehicle is received from the driver or an autonomous agent, through the analysis of the vehicle data.

9. The method of claim 7, further comprising:
generating intervention pattern information about intervention of the driver to provide the driver with the intervention pattern information; and
comparing the intervention pattern information with preset reference information to provide a visual or audio alarm associated with the intervention of the driver.

10. The method of claim 7, wherein the determining includes:
evaluating stability of autonomous driving based on situation information including at least one of whether devices necessary for the autonomous driving of the autonomous vehicle fail, weather at a current location, time, a traffic condition, and road information.

11. The method of claim 10, further comprising:
providing the driver with recommendation information for recommending intervention of the driver when the stability of the autonomous driving is lower than a preset reference stability.

12. The method of claim 7, wherein the determining includes:
determining whether the driver intervenes in at least one of deceleration, acceleration, steering, gear shifting, and an operation of a turn signal of the autonomous vehicle, intervention time in which the driver intervenes, and intervention strength of the driver.
